(19) United States
(12) Patent Application Publication
(10) Pub. No.: US 2025/0156969 A1
(43) Pub. Date: May 15, 2025

(54) System for Evaluating Safety of Hydrogen Station and Evaluation Method Using Same

(71) Applicant: Korea Gas Safety Corporation, Chungcheongbuk-do (KR)

(72) Inventors: Dong Hoon LEE, Gangwon-do (KR); Gi Yeog HA, Gangwon-do (KR); Keun Seon SIM, Gangwon-do (KR); Hee Jun SHIM, Gangwon-do (KR); Byeong Han KIM, Gangwon-do (KR)

(21) Appl. No.: 18/840,486

(22) PCT Filed: Mar. 10, 2022
(86) PCT No.: PCT/KR2022/003375

§ 371 Date: Aug. 21, 2024

(30) Foreign Application Priority Data
Feb. 28, 2022 (KR) 10-2022-0025660

(51) Int. Cl. G06Q 50/06; B60S 5/02

(52) U.S. Cl. CPC G06Q 50/06; B60S 5/02

(57) ABSTRACT

An embodiment of the present invention provides a system for evaluating the safety of a hydrogen station and an evaluation method using the same, which evaluate the performance and safety of the hydrogen station in which hydrogen charging takes place, so that hydrogen charging can be done more safely and smoothly.

### TECHNICAL FIELD

The present invention relates to a system for evaluating safety of a hydrogen station and an evaluation method using the same, and more particularly, to a system for evaluating safety of a hydrogen station that evaluates the performance and safety of the hydrogen station where hydrogen charging is performed so that hydrogen charging may be performed more safely and smoothly, and an evaluation method using the same.

### BACKGROUND ART

The contents described below are only described for the purpose of providing background information related to an embodiment of the present invention, and the contents described below do not naturally constitute the prior art.

Energy is the ability to do work and exists in positional, kinetic, thermal, electrical, chemical, nuclear, or many other forms.

A common method of energy production is using fossil fuels. The fossil fuels refer to energy resources stored underground, such as coal, petroleum, natural gas, oil shales, and tar sands, which are derived from animal or plant fossils.

Most of the energy currently used by human beings comes from non-cyclical depletable resources such as fossil fuels and uranium resources. In addition, the fossil fuels and uranium resources include problems such as global warming and air pollution.

Therefore, the need for energy that can replace the depleting fuels and protect the earth and environment is increasing.

Accordingly, research on renewable energy is actively underway. The renewable energy refers to energy obtained from resources that may be replenished repeatedly, such as the sun, wind, river, hot springs, tides, and biofuels.

In particular, automobiles use petroleum, a representative fossil fuel, as their main fuel, but hydrogen fuel is attracting attention as a new renewable energy that may replace the petroleum.

The hydrogen fuel used in automobiles produces electrical energy using chemical cells. Electric vehicles using the hydrogen fuel have the advantage of being environmentally friendly since they not only make a quiet sound while driving and have excellent acceleration performance, but also do not produce environmental pollutants.

In addition, the hydrogen fuel has the advantage of being able to complete charging in a short period of time.

However, the hydrogen fuel has limitations in that it should maintain a predetermined temperature and pressure range when stored in a charging station or while being charged in a vehicle using hydrogen as fuel.

In addition, the hydrogen fuel should be thoroughly prevented from leaking, and sufficient safety facilities should be provided when normal charging may not be performed.

In addition, as the hydrogen station becomes more popular, the need for an objective and accurate evaluation system that may inspect and evaluate the normal operation and safety of the hydrogen station is increasing.

Korean Patent No. 10-2070948 (hereinafter referred to as ‘Related Art 1’) discloses ‘Movable Hydrogen Evaluation Facility Device.’ The disclosed related art 1 describes technology related to an evaluation facility device that can perform various hydrogen evaluation inspections, such as whether hydrogen is supplied in a fixed amount to hydrogen vehicles and whether the pressure and temperature of hydrogen are maintained at a normal state during hydrogen supply, and can be loaded on a trailer and transported to remote locations.

However, there is a limitation in that, due to the absence of an evaluation method of evaluating and inspecting various inspection items, it is difficult to evaluate the hydrogen station, and the situation of charging hydrogen into a pressure vessel in which hydrogen is charged should be repeated several times.

In addition, a separate system for evaluating the safety of the evaluation device for evaluating the hydrogen station has not been implemented, so when evaluating the evaluation system for evaluating the hydrogen station, there is a limitation in that it is difficult to find a way to utilize data values of control and sensors of each valve of the evaluation system.

In addition, when hydrogen is charged and stored or released at high pressure (e.g., 70.0 Mpa or higher, [additional] 15° C. standard), the pressure and temperature of the pressure vessel in which the hydrogen is stored may change rapidly due to the absence of the separate system to control the pressure and temperature, so there is also a limit to the risk of exposure to safety accidents due to damage to the pressure vessel and hydrogen leakage.

The above-described background art is technical information retained by the inventor to derive the present invention or acquired by the inventor while deriving the present invention, and thus should not be construed as art that was publicly known prior to the filing date of the present invention.

### DISCLOSURE OF INVENTION

### Technical Problem

One object of the embodiment of the present invention is to provide a system for evaluating safety of a hydrogen station capable of objectively and accurately evaluating the normal operation and safety of the hydrogen station, and an evaluation method using the same.

One object of an embodiment of the present invention is to provide a system for evaluating the safety of a hydrogen station capable of evaluating the performance of a hydrogen station even by charging hydrogen only once into a pressure vessel in which hydrogen is charged, and an evaluation method using the same.

In addition, an object of an embodiment of the present invention is to provide a system for evaluating safety of a hydrogen station in which a separate system is provided for evaluating the safety of an evaluation system for evaluating the performance of the hydrogen station, and an evaluation method using the same.

In addition, an object of an embodiment of the present invention is to provide a system for evaluating safety of a hydrogen station capable of controlling the charging, storage, or release of high-pressure hydrogen, and an evaluation method using the same.

The object of the present invention is not limited to the above-mentioned object, and other objectives and advantages of the present invention that are not mentioned may be understood by the following description and will be more clearly understood by embodiments of the present invention. In addition, it will be appreciated that the object and advantages of the present invention may be realized by means indicated in the scope of the patent claim and a combination thereof.

### Solution to Problem

According to an embodiment of the present invention, a method of evaluating safety of a hydrogen station includes performing a charging operation of the hydrogen station that supplies hydrogen to a hydrogen vehicle using hydrogen as fuel, evaluating charging safety of the hydrogen station based on the charging operation, and when the charging operation does not match a preset evaluation criterion for charging safety of the hydrogen station, releasing the hydrogen charged in the hydrogen station.

According to an embodiment of the present invention, the evaluating of the charging safety of the hydrogen station may include determining a preset safety evaluation criterion for the hydrogen station and an operating condition of the hydrogen station during the charging operation.

According to an embodiment of the present invention, in the determining of the operating condition of the hydrogen station, one of an operation command determination that enables the hydrogen charging by the hydrogen station and a driving performance determination of the hydrogen storage module compared to pre-stored performance of the hydrogen storage module of the hydrogen station may be determined.

According to an embodiment of the present invention, in the evaluating of the charging safety of the hydrogen station, the charging safety of at least one of the following conditions may be evaluated: a preset temperature, pressure, and hydrogen flow rate of the hydrogen storage module of the hydrogen station, hydrogen leakage from the hydrogen storage module, ambient temperature within the hydrogen storage module, and a hydrogen storage capacity of the hydrogen storage module.

According to an embodiment of the present invention, the executing of the charging operation of the hydrogen station may include charging hydrogen from the hydrogen station based on an abnormal charging operation that is different from the conditions of the charging operation to be performed, and the determining may include determining whether the hydrogen is charged from the hydrogen station even when the abnormal charging operation is performed.

According to an embodiment of the present invention, the releasing of the hydrogen charged in the hydrogen station may include determining whether the charging operation condition deviates from the hydrogen storage condition preset in the hydrogen storage module of the hydrogen station.

According to an embodiment of the present invention, the determining of whether the charging operation condition deviates from the hydrogen storage condition may include determining an upper limit of the hydrogen storage conditions, determining whether the determined upper limit is close to the hydrogen storage condition, and when the determined upper limit is close to the hydrogen storage condition, releasing the hydrogen charged in the hydrogen station.

According to an embodiment of the present invention, the releasing of the hydrogen charged in the hydrogen station may include, when charging the hydrogen in the hydrogen vehicle, generating an arbitrary abnormal charging operation command to the hydrogen station, and determining whether the hydrogen is released from the hydrogen station based on the arbitrary abnormal charging operation command occurred.

According to an embodiment of the present invention, the method may further include when the charging operation does not match the evaluation criterion, stopping the charging operation.

According to another embodiment of the present invention, a system for evaluating safety of a hydrogen station includes an execution unit that executes a charging operation of the hydrogen station that supplies hydrogen to a hydrogen vehicle using hydrogen as fuel, an evaluation unit that evaluates charging safety of the hydrogen station based on the charging operation, and when the charging operation does not match a preset evaluation criterion for charging safety of the hydrogen station, a vent unit that releases the hydrogen charged in the hydrogen station.

According to still another embodiment of the present invention, a system for evaluating safety of a hydrogen station includes a processor, and a memory that is electrically connected to the processor and stores at least one code performed by the processor, in which when the memory is executed through the processor, the processor may execute a charging operation of the hydrogen station that supplies hydrogen to a hydrogen vehicle using the hydrogen as fuel, evaluate the charging safety of the hydrogen station based on the charging operation, and when the charging operation does not match the preset evaluation criterion for charging the safety of the hydrogen station, store codes for releasing the hydrogen charged in the hydrogen station.

The above-described aspects, features, and advantages and other aspects, features, and advantages will become obvious from the following drawings, claims, and detailed description of the present invention.

### Advantageous Effects of Invention

According to embodiments of the present invention, it can be quickly confirmed a change in settings of a hydrogen station, which should maintain a predetermined temperature and pressure range, while hydrogen fuel is stored in a charging station or in the process of charging a vehicle using hydrogen as fuel. Specifically, even if the predetermined temperature and pressure range are arbitrarily changed, when the hydrogen charging of the hydrogen station is performed, the hydrogen charging can be immediately stopped to prevent the hydrogen charging from being performed when the preset settings of the hydrogen station are changed.

In addition, according to embodiments of the present invention, it is possible to quickly and accurately inspect and evaluate the operating performance and safety of the hydrogen station. In other words, in order to determine whether there is the abnormality in an operation of a hydrogen charger, even when arbitrary abnormality information is input to the hydrogen station, the hydrogen station charges an evaluation system, it is possible to determine the abnormality of the hydrogen station and quickly stop the hydrogen charging.

In addition, according to embodiments of the present invention, it is possible to provide the evaluation system that inspects or evaluates the normal operation and safety of the hydrogen station. Specifically, by performing various hydrogen evaluation inspections, such as whether the pressure and temperature of hydrogen are maintained at a normal state while supplying hydrogen to a hydrogen vehicle, it is possible to charge and release hydrogen even a smaller number of times than the conventional evaluation method that performs the hydrogen charging and releasing process multiple times.

For example, when errors in the hydrogen station are detected, by releasing the hydrogen from a hydrogen storage module in which hydrogen is charged and re-performing the charging and evaluation of only the charged hydrogen storage module, it is possible to perform the evaluation of the hydrogen station at a faster rate.

The effects of the present invention are not limited to those mentioned above, and other effects not mentioned will be clearly understood by those skilled in the art from the following description.

### BRIEF DESCRIPTION OF DRAWINGS

FIG. 1 is a diagram schematically illustrating an environment of a performance and safety evaluation system of a hydrogen station according to an embodiment of the present invention.

FIG. 2 is a diagram illustrating an embodiment of an evaluation system for evaluating the performance and the safety of the hydrogen station according to an embodiment of the present invention.

FIG. 3 is a diagram illustrating a configuration of the safety evaluation system of the hydrogen station according to an embodiment of the present invention.

FIG. 4 is a diagram illustrating a hydraulic circuit diagram of the safety evaluation system of the hydrogen station according to an embodiment of the present invention.

FIGS. 5 and 6 are diagrams illustrating a communication charging evaluation method and a non-communication charging evaluation method of a performance and safety evaluation method of the hydrogen station according to an embodiment of the present invention.

FIG. 7 is a diagram illustrating a performance and safety evaluation process of the hydrogen station according to an embodiment of the present invention.

FIG. 8 is a diagram illustrating the performance and safety evaluation process of the hydrogen station according to an embodiment of the present invention.

FIGS. 9 and 10 are flowcharts illustrating the performance and safety evaluation method of the hydrogen station according to an embodiment of the present invention.

### BEST MODE FOR CARRYING OUT THE INVENTION

Hereinafter, an embodiment of the present specification will be described in detail with reference to the accompanying drawings, but the same or similar components will be given the same reference numbers regardless of the drawing codes, and redundant descriptions thereof will be omitted. The suffixes “modules” and “parts” for components used in the following description are given or mixed with the ease of specification, and do not have distinct meanings or roles by themselves. Furthermore, when it is determined that a detailed description of the related known technology in describing the embodiment invented in this specification may obscure the gist of the embodiment invented in this specification, the detailed description thereof is omitted. In addition, the attached drawings are only intended to facilitate understanding of the embodiments of this invention, and the technical idea of this invention is not limited by the attached drawings, and should be understood to include all changes, equivalents, or substitutes included in the spirit and technical scope of this invention.

Terms including ordinal numbers, such as first and second, may be used to describe various components, but the above components are not limited by the above terms. The above terms are used only for the purpose of distinguishing one component from another component.

When a component is referred to as “connected” or “accessed” to another component, it should be understood that another component may exist in the middle, although it may be directly connected to or connected to that other component. On the other hand, when a component is referred to as “directly connected” or “directly accessed” to another component, it should be understood that no other component exists in the middle.

Singular expressions include multiple expressions unless the context clearly indicates otherwise.

In this application, the terms “including” or “having” or “comprising” are intended to specify the existence of features, numbers, steps, actions, components, components, or a combination thereof described in the specification and should be understood not to preclude the existence or addition of one or more other features, numbers, steps, actions, components, components, or combinations thereof.

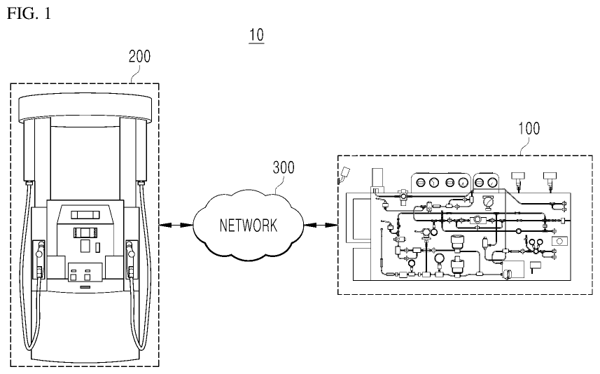

FIG. 1 is a diagram schematically illustrating an environment of a performance and

safety evaluation system of a hydrogen station according to an embodiment of the present invention.

Specifically, an environment 10 for implementing the performance and safety evaluation system of the hydrogen station may be configured to include an evaluation system 100 for evaluating the performance of the hydrogen station and a hydrogen station 200.

The evaluation system 100 is a device that inspects and evaluates the performance of the hydrogen station 200, such as whether the hydrogen station 200 operates normally and whether safety is maintained in the process of charging hydrogen fuel to a vehicle using hydrogen as fuel. Therefore, the evaluation system 100 according to an embodiment of the present invention may be configured to check the process of directly charging hydrogen by connecting the hydrogen station 200.

The hydrogen station 200 is a device that supplies hydrogen to a hydrogen vehicle using hydrogen as fuel, and when supplying hydrogen to the hydrogen vehicle, may store a charging operation of allowing the hydrogen station 200 to supply hydrogen normally. In addition, when hydrogen is supplied due to an abnormal charging operation while supplying hydrogen to the hydrogen vehicle based on a pre-stored charging operation, a command, etc., to stop the operation of the hydrogen station 200 may be stored.

The network 300 may communicate the hydrogen station 200 and the evaluation system 100, and may be composed of one of various wireless networks, short-distance and/or long-distance communication, but the present invention is not limited by the type of network 300.

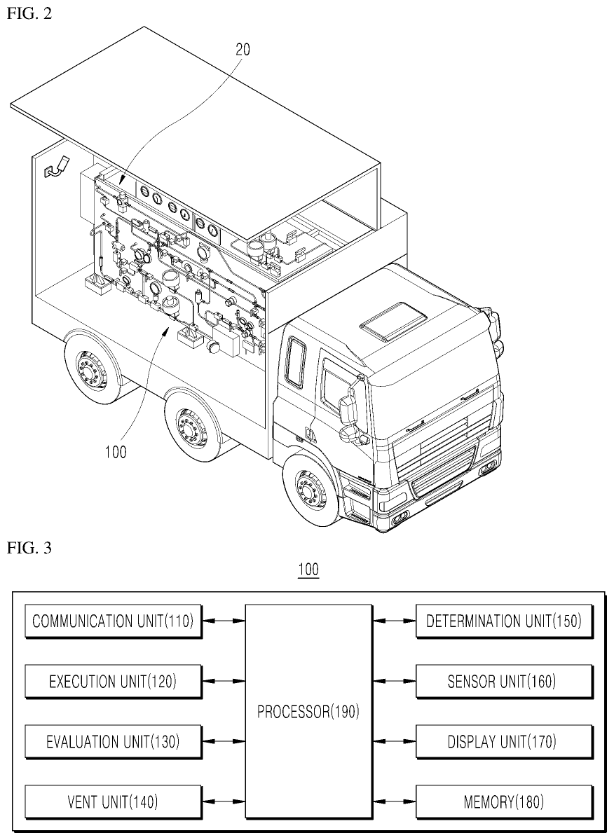

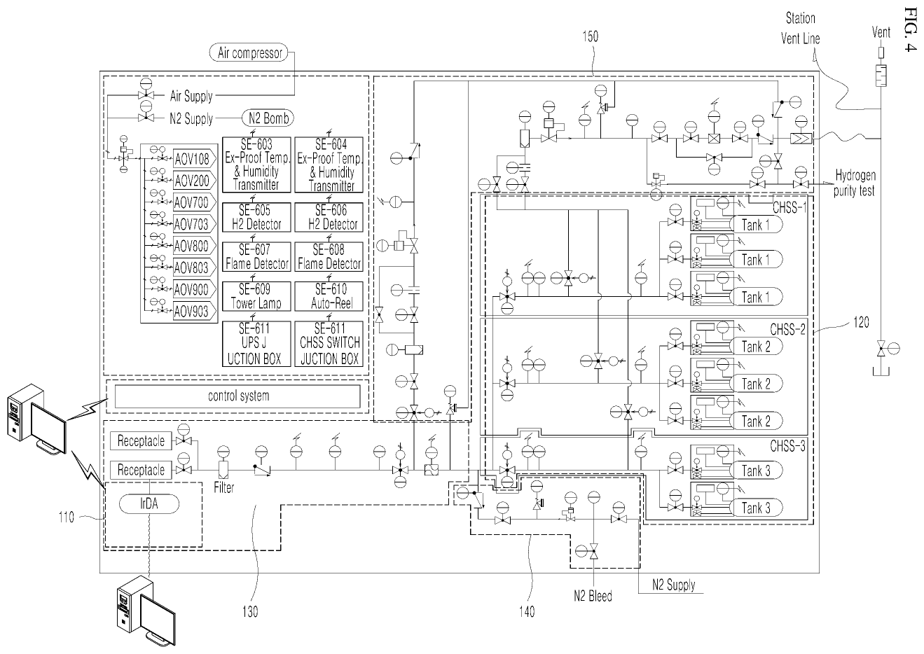

FIG. 2 is a diagram illustrating an embodiment of an evaluation system for evaluating the performance and the safety of the hydrogen station according to an embodiment of the present invention, FIG. 3 is a diagram illustrating a configuration of the safety evaluation system of the hydrogen station according to an embodiment of the present invention, and FIG. 4 is a diagram illustrating a hydraulic circuit diagram of the safety evaluation system of the hydrogen station according to an embodiment of the present invention.

Prior to describing the drawings, the evaluation system 100 according to an embodiment of the present invention is a system that evaluates the charging performance of the hydrogen station in the same environment as the vehicle using hydrogen as fuel. In order to evaluate the charging performance of the hydrogen station 200, by inputting an arbitrary abnormal charging operation signal to the hydrogen station 200 and determining when the hydrogen station 200 supplies hydrogen to the hydrogen vehicle according to the input arbitrary abnormal charging operation, it is possible to evaluate the charging safety of the hydrogen station.

Prior to the description, the evaluation system 100 may include a main body 20 that implements the evaluation system 100 as illustrated in FIG. 2. The main body 20 is a box formed with a predetermined internal space, and may be provided with a hydrogen storage module filled with hydrogen and pipes through which hydrogen can move. In addition, the main body 20 is composed of a sturdy framework and may be designed to protect the hydrogen storage module from external shock.

As illustrated in FIG. 3, the evaluation system 100 implemented from the main body 20 includes a communication unit 110, an execution unit 120, an evaluation unit 130, a vent unit 140, a determination unit 150, a sensor unit 160, a display unit 170, a memory, a processor 190, etc.

The communication unit 110 may transmit and receive data with other devices through wired or wireless communication or an interface.

The execution unit 120 may store an operation command for supplying hydrogen from a plurality of hydrogen storage modules in which hydrogen is stored to a hydrogen vehicle. That is, when the hydrogen station 200 performs a charging operation of supplying hydrogen to the hydrogen vehicle, the execution unit 120 executes a command to supply the hydrogen stored in the hydrogen storage module to the hydrogen vehicle.

Meanwhile, before the driving of the hydrogen station 200 is executed by the execution unit 120, the operation of the evaluation system 100 for evaluating whether to match the conditions for driving the hydrogen station 200 and the driving state of the hydrogen station 200 where actual hydrogen charging is performed may be evaluated.

The operation of the evaluation system 100 may be evaluated by the evaluation unit 130, and the evaluation unit 130 may evaluate the charging safety of the hydrogen station 200 based on the previous charging operation.

Specifically, the evaluation unit 130 may select items to evaluate the hydrogen station 200. For example, when the hydrogen station 200 charges hydrogen in the hydrogen vehicle, the evaluation unit may evaluate whether the hydrogen is charged from the hydrogen station 200 by arbitrarily changing the charging conditions.

For example, in order to evaluate the safety of the hydrogen station 200, evaluation criteria for safely charging the hydrogen by the hydrogen station 200 and operating conditions when the actual hydrogen station 200 supplies hydrogen to the hydrogen vehicle may be matched and determined. In this case, if the evaluation criteria and operating conditions do not match, it is determined that the safe hydrogen charging of the hydrogen station 200 is not performed.

In particular, the evaluation unit 130 may evaluate items related to the safety and performance of the hydrogen station 200 based on criteria classified according to preset conditions. For example, the evaluation unit 130 may evaluate the evaluation items of the hydrogen station 200 by largely dividing the evaluation items into communication charging and non-communication charging categories.

Here, the communication charging evaluation may be an operation command that enables the hydrogen charging by the hydrogen station, and may be evaluated based on the SEA J2799-based IR communication method. In addition, when hydrogen is charged from hydrogen station 200, the communication charging evaluation evaluates conditions such as temperature, pressure, and hydrogen capacity of the hydrogen storage container installed in the hydrogen vehicle, and when the conditions are greater than or equal to the set conditions, the hydrogen charging may be performed by the hydrogen station 200. When this communication charging evaluation deviates from the conditions, the hydrogen charging of the hydrogen vehicle is stopped and the execution is stopped, so it is possible to perform the hydrogen charging of the vehicle and charging station more safely.

Specifically, the communication charging evaluation of the charging evaluation may evaluate a driving command for driving the hydrogen station 200. The stopping, operation, etc., of the hydrogen station may be referred to as the driving command. Both the case where the hydrogen station 200 is not driven even if the driving command is input and the case where the hydrogen station 200 is driven even if the driving command is not input may be the communication charging evaluation criteria for evaluating the performance of the hydrogen station 200.

In addition, in the case where the hydrogen is charged from the hydrogen station 200, when an incorrect input value (e.g., abnormal charging operation) is input to the hydrogen station 200, by determining whether the hydrogen is charged from the hydrogen station 200, it is possible to evaluate whether the communication of the hydrogen station 200 is being performed appropriately.

In addition, the communication charging evaluation may receive a charging command TV, an internal capacity (separate error evaluation) MP of a storage container, an internal pressure (separate error evaluation) MT of a storage container, an internal temperature (separate error evaluation) of a storage container, etc., through IR communication (based on SAE J2799) FC from the evaluation system to the charger. Accordingly, the evaluation may be performed based on a charger's response, a data loss, etc.

The non-communication charging evaluation means evaluating the charging method by confirming only the pressure using the charger's own sensor, rather than transmitting data through the communication of the hydrogen station 200. In other words, since the temperature of the container may be unknown, evaluating the conditions for charging using the existing method may be referred to as the non-communication charging evaluation.

Specifically, the non-communication charging evaluation may evaluate whether the temperature of the hydrogen is controlled during the charging of the hydrogen, whether the pressure of the hydrogen is controlled during the charging of the hydrogen, whether the flow rate of the hydrogen is controlled during the charging of the hydrogen, whether the hydrogen is leaking, whether the surrounding environment, such as hydrogen pressure, temperature, and ambient temperature, is measured during the charging of the hydrogen, conditions for the hydrogen storage module to store the hydrogen, etc.

In this case, the hydrogen leakage evaluation may be performed in both the communication and non-communication charging evaluations. For example, the leakage evaluation of the communication charging evaluation may be evaluated by communication between gas leakage detection sensors installed in each pipe or hydrogen storage module and the communication unit 110, and the leakage evaluation of the non-communication charging evaluation may evaluate the hydrogen gas leakage by evaluating mechanical defects in valves in each pipe, etc.

Specifically, the communication charging evaluation may be determined as a leakage when the pressure rise rate (APRR) is not satisfied using the pressure data transmitted from the evaluation system 100, and the non-communication charging evaluation may use the charger's own pressure sensor to detect leakage through idle periods during charging (stop, pressure equalization from charger sensor to storage vessel, etc.).

The vent unit 140 is configured to release the hydrogen charged in the hydrogen station 200 when the evaluation criteria based on the charging safety of the hydrogen station 200 and the charging operation of the hydrogen station 200 do not match.

The vent unit 140 may release hydrogen stored in the hydrogen storage module to the outside. To this end, a command for an arbitrary “hydrogen leakage situation” may be input to the hydrogen station 200 during the hydrogen charging process. In this case, in the hydrogen station 200, the same environment as the situation in which the hydrogen fuel leaks may be created. In this case, as the charging operation, an operation such as “stop charging” should be executed. However, when the hydrogen station 200 continues to charge hydrogen even though the situation such as a hydrogen leakage occurs, the safety of the hydrogen station 200 should be confirmed, so the hydrogen stored in the hydrogen storage module is completely discharged to the outside through the execution of the vent unit 140, thereby securing the stability of the hydrogen station 200.

That is, when releasing the hydrogen through the vent unit 140, if the charging operation conditions of the hydrogen station 200 deviate from the hydrogen storage conditions preset in the hydrogen storage module, the hydrogen may be released.

Here, the hydrogen storage conditions may be the temperature, pressure, flow rate, etc. within the hydrogen storage module when the hydrogen is charged, and the upper limit of hydrogen storage conditions, such as the temperature and pressure of hydrogen stored in the hydrogen storage module, the flow rate of hydrogen during the charging of the hydrogen, the maximum storage rate of hydrogen stored in the hydrogen storage module, etc., may be preset.

After determining whether the upper limit of the hydrogen storage condition set in this way is adjacent to the hydrogen storage condition, when the upper limit is close to the hydrogen storage condition or is greater than or equal to the hydrogen storage condition, the hydrogen stored in the hydrogen storage module may be released to the outside.

The vent unit 140 may discharge air or foreign substances that may remain in pipes, etc., to the outside. By allowing nitrogen to be released through the pipe and execution unit 120 by the vent unit 140, the environment in which more accurate inspection and evaluation may be performed may be created.

In this hydrogen safety evaluation, the determination unit 150 of the evaluation system 100 determines when the hydrogen is charged from the hydrogen station 200 even if the abnormal charging operation is input to the hydrogen station 200.

In other words, after an arbitrary “hydrogen leakage situation” is input to the hydrogen station 200, when the next action to be performed by the hydrogen station 200, the “stop hydrogen charging,” is not performed, the determination unit 150 is configured to determine that there is a problem with the safety of the hydrogen station 200.

In this way, in the process of charging hydrogen, a “hydrogen leakage environment” is arbitrarily created in a predetermined section, and the hydrogen station 200 may detect the created environment to inspect and evaluate whether it reacts normally.

The sensor unit 160 may sense the temperature, pressure value, gas leakage, etc., of the hydrogen fuel stored in the hydrogen storage module, and the sensed result values may be transmitted to the hydrogen station 200 and/or the processor 190.

Specifically, the sensor unit 160 may detect the hydrogen temperature inside the hydrogen storage module, and as the method of detecting temperature, both digital and analog methods may be used.

In addition, the sensor unit 160 may sense the flow rate of hydrogen. In this case, a mass flow rate controller (not illustrated) may be further included to ensure that the flow rate of charged hydrogen does not deviate from the preset flow rate range.

In addition, the sensor unit 160 may detect set gas components. That is, the hydrogen may be detected through the sensor unit 160, and when hydrogen gas greater than or equal to a preset concentration is detected, related information may be configured to be transmitted to the processor 190 and/or the hydrogen station 200.

The display unit 170 may be installed on the main body 20, and the display unit 170 is configured to confirm data on the hydrogen performance and safety evaluation process. The data displayed on the display unit 170, such as information on hydrogen leakage, information on occurrence of abnormal signals, and data on communication connection failure with the evaluation system 100 that evaluates the safety of the hydrogen storage module and the hydrogen station, may be either digital or analog data.

The memory 180 may store the information for setting the hydrogen charging information with the evaluation system 100 in which hydrogen is charged based on the hydrogen storage information for the hydrogen storage module to store the hydrogen. That is, when the hydrogen is charged in the evaluation system 100, the memory 180 inputs the abnormality information to the hydrogen station 200, and may store data and commands for evaluation criteria for whether the hydrogen station 200 continues to charge hydrogen based on the input abnormality information.

The processor 190 may control the overall operation of the evaluation system 100 in addition to the operations related to the application program stored in the memory 180. The processor 190 may provide or process appropriate information or a function to a target by processing signals, data, information, and the like, which are input or output through the above-described components, or by driving an application program stored in the memory 56.

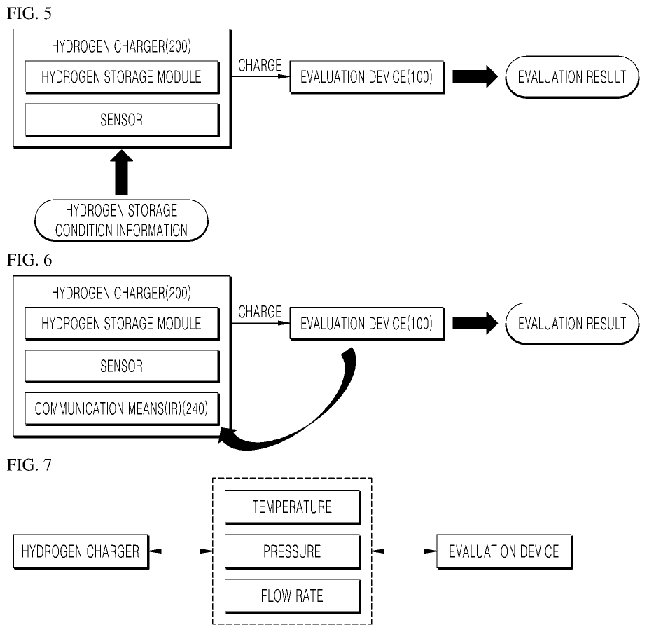

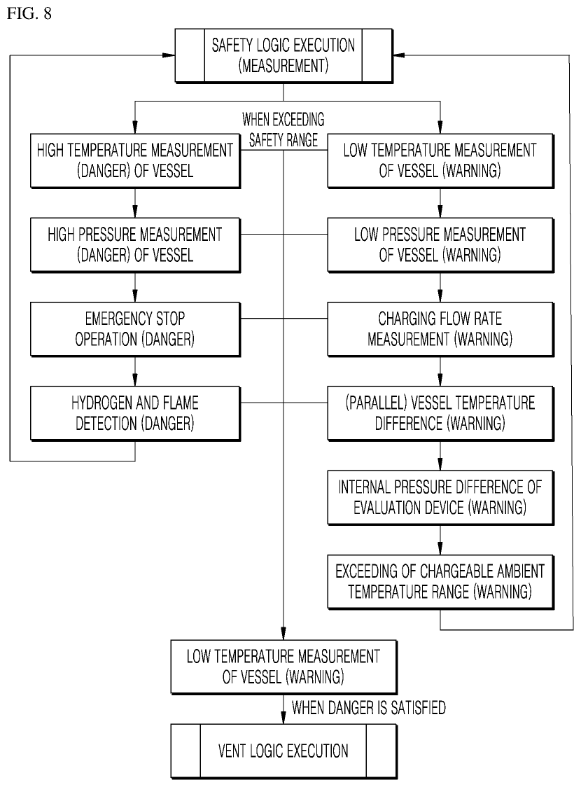

FIGS. 5 and 6 are diagrams illustrating a communication charging evaluation method and a non-communication charging evaluation method of the performance and safety evaluation method of the hydrogen station according to an embodiment of the present invention, and FIG. 7 is a diagram illustrating the performance and safety evaluation process of the hydrogen station according to an embodiment of the present invention.

The performance and safety evaluation method of the hydrogen station 200 according to the embodiment of the present invention may be largely divided into the communication evaluation and the non-communication evaluation.

First, the performance and safety evaluation method of the hydrogen station 200 through the non-communication evaluation will be described with reference to FIGS. 5 and 6.

The non-communication evaluation means conservatively evaluating hydrogen charging using initial measurement data. Specifically, for the non-communication evaluation, the storage capacity of the hydrogen storage module, the ambient temperature within the hydrogen storage module, the supply temperature of hydrogen supplied to the hydrogen storage module, and the initial pressure within the hydrogen storage module may be measured independently.

Thereafter, a final target pressure and an average pressure rise rate of the hydrogen storage module are set based on the measured data, and when the evaluation system 100, which is a charging target, is before or during charging according to set conditions, the charging safety of the hydrogen station 200 may be evaluated through the process of inspecting and evaluating whether the hydrogen station 200 operates within a specified normal range.

The communication charging evaluation means that the hydrogen station 200 and the evaluation system 100 are connected by IR communication (infrared communication) to measure the temperature and pressure of the hydrogen storage module in real time before charging the hydrogen station 200 and/or during the charging process.

Specifically, for the communication charging evaluation, the storage capacity of the hydrogen storage module, the ambient temperature within the hydrogen storage module, the supply temperature of hydrogen supplied to the hydrogen storage module, and the initial pressure within the hydrogen storage module may be measured independently. Depending on the measured conditions, the final target pressure and average pressure rise rate of the hydrogen storage module may be determined.

These non-communication charging and communication evaluations may be performed simultaneously, but preferably, the non-communication charging evaluation may be performed first and then the communication evaluation may be performed later. This is because when the communication is stopped during the communication charging evaluation, the communication charging should switch to the non-communication charging or stop the charging.

The embodiment of the present invention will be described as an example in which the communication charging evaluation is performed after the non-communication charging evaluation, and the process of evaluating the charging safety of the hydrogen station 200 through the non-communication charging evaluation and the communication charging evaluation is as follows.

When the evaluation system 100 and the hydrogen station 200 communicate with each other, the detailed information (e.g., identification information, charging command, charging port type, storage capacity of the hydrogen storage module, real-time pressure and temperature, etc.) of the hydrogen station 200 may be transmitted to the communication unit 110 of the evaluation system 100.

When the detailed information of the hydrogen station 200 is transmitted to the communication unit 110, the evaluation system 100 may perform and evaluate the process of the hydrogen station 200 charging the evaluation system 100 and/or whether the hydrogen station 200 in the state before charging the evaluation system 100 operates in an appropriate range.

That is, as illustrated in FIG. 7, the non-communication charging evaluation and the communication charging evaluation evaluate the occurrence of abnormal signals, the gas leakage, the normal charging or not, the communication connection between the evaluation system 100 and the hydrogen station 200 in the hydrogen station 200 and/or the evaluation system 100, etc., between the hydrogen station 200 and the evaluation system 100.

The hydrogen charging safety evaluation method of the hydrogen station 200 will be described with reference to the drawings below.

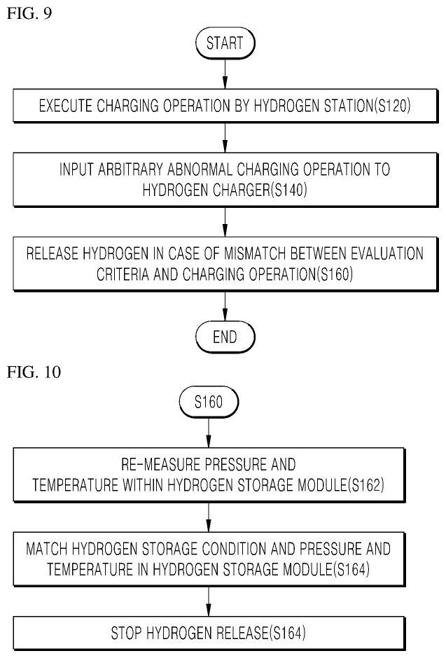

FIG. 8 is a diagram illustrating the performance and safety evaluation process of the hydrogen station according to an embodiment of the present invention, and FIGS. 9 and 10 are flowcharts illustrating the performance and safety evaluation method of the hydrogen station according to an embodiment of the present invention.

Referring to the drawings, before executing the charging operation of charging the hydrogen of the hydrogen station 200, the evaluation criteria in which the hydrogen station 200 stably charges hydrogen may be stored in the evaluation system 100.

The hydrogen station 200 may perform the charging operation of charging the hydrogen while the evaluation criteria are pre-stored in the evaluation system 100 (step S120).

Here, the evaluation criteria may refer to information such as the storage capacity of the hydrogen storage module, the ambient temperature within the hydrogen storage module, the supply temperature of hydrogen supplied to the hydrogen storage module, the initial pressure within the hydrogen storage module, etc. and the hydrogen charging information may refer to hydrogen storage conditions such as the final target pressure, the average pressure rise rate, etc., of the hydrogen storage module set based on the measured data.

The hydrogen storage conditions are set, and the hydrogen is charged in the hydrogen vehicle at the hydrogen station 200 based on the set hydrogen storage conditions (step S140). In this case, arbitrary abnormal charging operation is input to the hydrogen station 200. The safety and performance of the hydrogen station may be evaluated based on the input abnormal charging information.

For example, the pressure data for arbitrary “hydrogen leakage situation” may be input to the hydrogen station 200 during the hydrogen charging process. In this case, in the hydrogen station 200, the same environment as the situation in which the hydrogen fuel leaks may be created. In this case, as the charging operation, the operation such as “stop charging” should be executed. However, when the hydrogen station 200 continues to perform the hydrogen charging even if the situation such as the hydrogen leakage occurs, the safety of the hydrogen station 200 should be confirmed.

On the other hand, when the hydrogen station 200 continues to charge hydrogen even if the situation such as a hydrogen leakage occurs, the vent unit 140 operates to release all the hydrogen stored in the hydrogen storage module to the outside, thereby securing the safety of the hydrogen station 200 (step S160).

In this case, the hydrogen release conditions may be the temperature, the pressure, the flow rate, etc., within the hydrogen storage module when the hydrogen is charged, and refer to the case deviating from the pre-stored hydrogen storage conditions such as the temperature and pressure of the hydrogen stored in the hydrogen storage module, the flow rate of the hydrogen during the charging of the hydrogen, and the maximum storage rate of the hydrogen stored in the hydrogen storage module that are the upper limit of the hydrogen storage condition, and when the hydrogen charging is performed deviating from the hydrogen storage conditions, the hydrogen may be released.

Meanwhile, the pressure and temperature within the hydrogen storage module may be re-measured during the hydrogen release. When the measured pressure, temperature, etc., correspond to the hydrogen storage conditions, venting (hydrogen release) may be stopped (steps S162, S164, and S166).

In this case, during the hydrogen release process, it is confirmed whether the temperature and pressure are lower than the lowest limit of the preset hydrogen storage conditions, and when the temperature, pressure, etc., of the hydrogen storage module reach the lowest limit, the hydrogen release is stopped.

Specifically, the hydrogen storage conditions may execute the venting when the temperature of the hydrogen storage module is high, such as greater than or equal to 87.5 MPa, and may be stored to continuously provide notification warnings so that the pressure can be maintained to greater than or equal to 0.5 MPa. In addition, when the pressure of the hydrogen storage module is high, such as higher than or equal to 85° C., the venting may be activated, and when the temperature is lower than or equal to −40° C., the venting may be set to notify the warning about the safety of the hydrogen charging. That is, the temperature and pressure of the hydrogen storage module may increase during the charging, and the temperature and pressure of the hydrogen storage module may decrease during the venting. According to these features, when the temperature and pressure are above the preset conditions during the charging, the rise in temperature and pressure may be notified, or when the temperature and pressure are below the preset conditions during the venting, the drop in temperature and pressure may be notified, so that the warning about the safety of the hydrogen charging may be notified.

In addition, the charging flow rate of the hydrogen charged in the hydrogen vehicle during the hydrogen charging may be limited. For example, when the flow rate is 60 g/s or more, the warning about the safety of the hydrogen charging may be set to be notified.

In addition, the temperature difference between the plurality of hydrogen storage modules may be set within +5° C., and when the pressure difference between the hydrogen storage module and the charging port for charging the hydrogen is 18 MPa to 22 MP, this may be set to notify the warning about the safety of the hydrogen charging.

Additionally, the ambient temperature may be set to −40° C. to 50° C., and when the ambient temperature range deviates from the set temperature, it may be set to perform the venting or notify the warning about the safety of hydrogen charging.

Meanwhile, when the charging operation is performed outside of the set hydrogen storage conditions, all valves of the hydrogen station 200 may be closed or the warning about the safety of the hydrogen charging may be notified.

When the charging operation is performed outside the hydrogen storage conditions even after the valve is closed, all the stored hydrogen is vented (released) to prevent the explosion due to the hydrogen in advance.

In this way, it is possible to quickly confirm a change in settings of the hydrogen station, which should maintain the predetermined temperature and pressure range, while the hydrogen fuel is stored in the charging station or in the process of charging the vehicle using hydrogen as fuel. Specifically, even if the predetermined temperature and pressure range are arbitrarily changed, when the hydrogen charging of the hydrogen station is performed, the hydrogen charging may be immediately stopped to prevent the hydrogen charging from being performed when the preset settings of the hydrogen station are changed.

In addition, according to embodiments of the present invention, it is possible to quickly and accurately inspect and evaluate the operating performance and safety of the hydrogen station. In other words, in order to determine whether there is the abnormality in the operation of the hydrogen charger, even when the arbitrary abnormality information is input to the hydrogen station, the hydrogen station charges the evaluation system, it is possible to determine the abnormality of the hydrogen station and quickly stop the hydrogen charging.

In addition, according to embodiments of the present invention, it is possible to provide the evaluation system that inspects or evaluates the normal operation and safety of the hydrogen station. Specifically, by performing various hydrogen evaluation inspections, such as whether the hydrogen is supplied in a fixed amount to the hydrogen vehicle, and whether the pressure and temperature of hydrogen are maintained at a normal state while supplying hydrogen to a hydrogen vehicle, it is possible to charge and release hydrogen even a smaller number of times than the conventional evaluation method that performs the hydrogen charging and releasing process multiple times.

For example, when the errors in the hydrogen station are detected, by releasing the hydrogen from the hydrogen storage module in which the hydrogen is charged and re-performing the charging and evaluation of only the charged hydrogen storage module, it is possible to perform the evaluation of the hydrogen station at a faster rate.

The description of the embodiment of the present invention described above is for illustrative purposes only, and those of ordinary skill in the art to which the present invention pertains will understand that it can be easily transformed into other specific forms without changing the technical idea or essential features of the present invention. Therefore, it should be understood that the embodiments described above are illustrative in all respects and are not limited. For example, each component described in a single form may be implemented in a distributed manner, and similarly, components described as distributed may be implemented in a combined form.

The scope of the present invention should be represented by the claims described below rather than the above detailed description, and all changes or modifications derived from the meaning and scope of the claims and their equivalent concepts should be construed as being included in the scope of the present invention.

1. A method of evaluating safety of a hydrogen station, comprising:
performing a charging operation of the hydrogen station that supplies hydrogen to a hydrogen vehicle using the hydrogen as fuel;
evaluating charging safety of the hydrogen station based on the charging operation; and
when the charging operation does not match a preset evaluation criterion for the charging safety of the hydrogen station, releasing the hydrogen charged in the hydrogen station.

2. The method of claim 1, wherein the evaluating of the charging safety of the hydrogen station includes determining preset safety evaluation criteria for the hydrogen station and an operating condition of the hydrogen station during the charging operation.

3. The method of claim 2, wherein in the determining, one of an operation command determination that enables the hydrogen charging by the hydrogen station and a driving performance determination of a hydrogen storage module compared to pre-stored performance of the hydrogen storage module of the hydrogen station is determined.

4. The method of claim 1, wherein in the evaluating of the charging safety of the hydrogen station, the charging safety of at least one of the following conditions is evaluated: a preset temperature, pressure, and hydrogen flow rate of the hydrogen storage module of the hydrogen station, hydrogen leakage from the hydrogen storage module, ambient temperature within the hydrogen storage module, and a hydrogen storage capacity of the hydrogen storage module.

5. The method of claim 2, wherein the executing of the charging operation of the hydrogen station includes charging the hydrogen from the hydrogen station based on an abnormal charging operation that is different from conditions of the charging operation to be performed, and
the determining includes determining whether the hydrogen is charged from the hydrogen station even when the abnormal charging operation is performed.

6. The method of claim 1, wherein the releasing of the hydrogen charged in the hydrogen station includes determining whether a charging operation condition deviates from a hydrogen storage condition preset in a hydrogen storage module of the hydrogen station.

7. The method of claim 6, wherein the determining of whether the charging operation condition deviates from the hydrogen storage condition includes:
determining an upper limit of the hydrogen storage conditions;
determining whether the determined upper limit is close to the hydrogen storage condition; and
when the determined upper limit is close to the hydrogen storage condition, the hydrogen charged in the hydrogen station is released.

8. The method of claim 5, wherein the releasing of the hydrogen charged in the hydrogen station includes:
when charging the hydrogen in the hydrogen vehicle, generating an arbitrary abnormal charging operation command to the hydrogen station; and
determining whether the hydrogen is released from the hydrogen station based on the arbitrary abnormal charging operation command occurred.

9. The method of claim 1, further comprising:
when the charging operation does not match the evaluation criterion, stopping the charging operation.

10. A system for evaluating safety of a hydrogen station, comprising:
an execution unit that executes a charging operation of the hydrogen station that supplies hydrogen to a hydrogen vehicle using the hydrogen as fuel;
an evaluation unit that evaluates charging safety of the hydrogen station based on the charging operation; and
when the charging operation does not match a preset evaluation criterion for charging safety of the hydrogen station, a vent unit that releases the hydrogen charged in the hydrogen station.

11. The system of claim 10, further comprising:
a determination unit that determines a preset safety evaluation criterion of the hydrogen station and an operating condition of the hydrogen station during the charging operation.

12. The system of claim 11, wherein the determination unit determines one of the following: an operation command determination for charging the hydrogen to the hydrogen station and a driving performance determination of a hydrogen storage module compared to a pre-stored performance of the hydrogen storage module of a hydrogen charger.

13. The system of claim 10, wherein the evaluation unit evaluates the charging safety of at least one of the following conditions: a preset temperature, pressure, and hydrogen flow rate of a hydrogen storage module of the hydrogen station, hydrogen leakage from the hydrogen storage module, ambient temperature within the hydrogen storage module, and a hydrogen storage capacity of the hydrogen storage module.

14. The system of claim 11, wherein the execution unit charges the hydrogen in the hydrogen station based on an abnormal charging operation that is different from conditions of the charging operation to be performed, and
the determination unit determines whether the hydrogen is charged in the hydrogen station even when the abnormal charging operation is performed.

15. The system of claim 10, wherein when a charging operation condition deviates from a hydrogen storage condition preset in a hydrogen storage module of the hydrogen station and an upper limit of the predetermined hydrogen storage condition is close to the hydrogen storage condition, the hydrogen charged in the hydrogen station is released.

16. A system for evaluating safety of a hydrogen station, comprising:
a processor; and
a memory that is electrically connected to the processor and stores at least one code performed by the processor,
wherein when the memory is executed through the processor, the processor executes a charging operation of the hydrogen station that supplies hydrogen to a hydrogen vehicle using the hydrogen as fuel, evaluates the charging safety of the hydrogen station based on the charging operation, and when the charging operation does not match a preset evaluation criterion for the charging safety of the hydrogen station, stores codes for releasing the hydrogen charged in the hydrogen station.
